(19) United States
(12) Patent Application Publication
(10) Pub. No.: US 2019/0328011 A1
(43) Pub. Date: Oct. 31, 2019

(54) Purification of Cooking Oils and Fats with Amino-Functionalized Silica Adsorbent Materials

(71) Applicants: Dennis N. Malaba, Uniontown, OH (US); Andrey Bagreev, Chesterfield, VA (US)

(72) Inventors: Dennis N. Malaba, Uniontown, OH (US); Andrey Bagreev, Chesterfield, VA (US)

(21) Appl. No.: 16/385,696

(22) Filed: Apr. 16, 2019

Related U.S. Application Data
(60) Provisional application No. 62/664,343, filed on Apr. 30, 2018.

(51) Int. Cl. A23L 5/20; B01J 20/10; B01J 20/28; B01J 20/30; C11B 13/00

(52) U.S. Cl. CPC A23L 5/273; B01J 20/103; B01J 20/28047; A23V 2002/00; B01J 20/3071; B01J 20/3078; C11B 13/00; B01J 20/28004

(57) ABSTRACT

A method of purifying cooking oil or fat by contacting the cooking oil or fat with at least one amino-functionalized silica adsorbent material, wherein the at least one amino-functionalized silica adsorbent material is not in the form of a cationic species. Such method provides for improved removal of free fatty acids from the cooking oil or fat without generating or producing soaps.

This application claims priority based on provisional Application Ser. No. 62/664,343, filed Apr. 30, 2018, the contents of which are incorporated by reference in their entirety.

This invention relates to the purification of oils and fats, such as edible oils, including cooking oils. More particularly, this invention relates to the purification of cooking oils and fats by contacting the cooking oil or fat with at least one amino-functionalized silica adsorbent material.

Most restaurant and industrial operations such as those involving the frying of foods in cooking oils or fats, in general use adsorbents containing alkaline earth metals, alone or in combination with alkali metal materials as filter media because such adsorbents are very effective in lowering free fatty acid concentrations in oil or fat. The free fatty acid concentration of the oil or fat is reduced by a combination of adsorption and neutralization. A product of the neutralization of a fatty acid with an alkaline metal is a fatty acid soap which becomes a residual product in the oil or fat. The amount of soap formed is dependent upon the amount of alkaline metal present, and the initial percentage of free fatty acids in the oil or fat. When the soap level is high, the oil or fat foams. The use of alkali materials to lower the free fatty acid concentration results sometimes in uncontrollable foaming. Moreover, leftover fatty acid soaps in oil do lead generally to the production of increased amounts of free fatty acids (so-called “runaway” free fatty acids) through base catalyzed hydrolysis of the oil. This can lead to shorter oil life if excess free fatty acids and soaps are not removed sufficiently.

U.S. Pat. No. 5,597,600, issued to Munson, et al., discloses a process for treating used cooking oil or fat that employs a combination of magnesium silicate and at least one alkali material selected from the group consisting of alkaline earth metal hydroxides, such as, for example, calcium hydroxide; alkaline earth metal oxides; alkali metal carbonates; alkali metal bicarbonates; alkaline earth metal carbonates; and alkali metal silicates.

U.S. Pat. No. 8,980,351, issued to Ulahanan, et al., discloses a method of treating used cooking oil which utilizes a powder consisting of a combination of sodium silicate and silica xerogel, which removes fatty acids, soaps, and particulates from used cooking oil.

U.S. Pat. No. 6,187,355, issued to Akoh, et al., discloses a method of treating used frying oils that employs combinations of adsorbents and antioxidants where the adsorbents are a ternary mixture comprising calcium silicate, magnesium silicate and at least one of a porous rhyolitic material and silicon dioxide in effective amounts to reduce free fatty acids as well as improve total polar component, oil stability, and color.

The removal of free fatty acids in cooking oil and fats occurs by adsorption and neutralization as exemplified in U.S. Pat. Nos. 5,597,600; 8,980,351; and 6,187,355. The product of the neutralization of a fatty acid with an alkali or alkaline metal is a fatty acid soap. The amount of soap formed is dependent on the amount of alkali or alkaline metal present, and the initial percentage of free fatty acids in the oil. When the soap level is high, the oil foams. The soaps generated are removable to a large extent by filtration and there may be residual soaps left after filtration.

Published PCT Patent Application No. WO2017/087836, of Fleming, et al., discloses cationic composite silicate filter aids that may be used in filtration applications, including the filtration of edible oils. Cationic composite filter aids described in the Fleming application may include a silicate substrate, a silica precipitated on the silicate substrate, and a cationic surface modification of the precipitated silica. The cationic surface modifying may employ at least one coupling agent and the coupling agent may include an amino-functional silane.

The cationic composite silicate filter aids are designed to remove ions or molecules that have negative charges from edible oil. Fleming, however, does not disclose that these cationic composite silicate filter aids may be used to remove free fatty acids from cooking oils or fats.

U.S. Patent Application No. US20100239679, of Greene, et al., discloses an amino-surface treated functional particulate carrier material, comprising at least one functional particulate carrier material wherein the at least one functional particulate carrier material is chosen from the group that includes synthetic silicates. This patent does not disclose use of such materials in the treatment of cooking oil.

U.S. Pat. No. 7,767,004, issued to Sayari, et al., discloses amino-functionalized adsorbents based on mesoporous silica for removal of acid gases formed from industrial processes via a dry scrubbing process. This patent does not disclose the removal of free fatty acids from cooking oil.

U.S. Pat. No. 5,087,597, issued to Leaf, et al., discusses amino-functional adsorbents based on silica gel and a method for producing the adsorbents which are used for the removal of carbon dioxide.

U.S. Patent Application No. US20160209305, of Kshirsagar, et al., discloses guanidine-functionalized metal silicate particles and methods of making and using such particles. The guanidine-functionalized metal silicate particles include metal silicate particles that are modified with at least one silane reagent having a guanidine group containing a primary amine-functional group having the formula —NH—C(═NH)—NH₂. The '305 application, however, does not disclose the treatment of cooking oil or fats to remove free fatty acids therefrom.

U.S. Patent Application No. US20180038862, of Kshirsagar, et al., discloses guanidine-functionalized perlite particles, and methods of making and using such particles. The particles are formed by modifying perlite particles with at least one silane reagent having a guanidine group containing a primary amine-functional group having the formula —NH—C(═NH)—NH₂. The '862 application, however, does not disclose the treatment of oil or fat to remove free fatty acids therefrom.

U.S. Pat. No. 4,100,112, issued to Blount, discloses a process for the production of amine silicate compounds that are formed by the chemical reaction of hydrated silica with an amine compound in the presence of a suitable alkali catalyst at an elevated temperature, and then reacting the resulting compounds with aldehydes, epoxys, organic dicarboxylic anhydrides, polycarboxylic acid compounds or carbon disulfide, thereby forming a resinous condensation product. This patent does not disclose the treatment of oil or fat to remove free fatty acids therefrom or the use of the above materials in food applications.

It is an object of the present invention to purify cooking oils and fats with an adsorbent material that removes free fatty acid from the oil or fat without generating free fatty acid soaps.

In accordance with an aspect of the present invention, there is provided a method of purifying cooking oil or fat. The method comprises contacting the cooking oil or fat with at least one amino-functionalized silica adsorbent material. The at least one amino-functionalized silica adsorbent material is not in the form of a cationic species. The cooking oil or fat is contacted with the amino-functionalized silica adsorbent material in an amount effective to purify the cooking oil or the fat.

In a non-limiting embodiment, the at least one amino-functionalized silica adsorbent material is produced by reacting at least one silica material with at least one reactive aminoalkylsilane.

In a non-limiting embodiment, the at least one silica material is selected from the group consisting of silica gel, magnesium silicate, calcium silicate, sodium silicate, aluminum silicate, sodium aluminum silicate, and combinations thereof. In another non-limiting embodiment, the at least one silica material is silica gel. In a further non-limiting embodiment, the at least one silica material is magnesium silicate.

Magnesium silicate is a compound containing magnesium oxide (MgO) and silicon dioxide (SiO₂), and may be hydrated. Magnesium silicate may have the formula MgO×SiO₂.mH₂O, wherein x is the molar ratio of SiO₂ to MgO, and m is the number of moles of chemically bound water.

Synthetic magnesium silicate is manufactured by effecting a precipitation reaction between a soluble magnesium salt, such as, for example, magnesium sulfate (MgSO₄), magnesium chloride (MgCl₂), or magnesium nitrate (Mg(NO₃)₂), and a metal silicate, such as, for example, sodium silicate.

In general, the magnesium salt and the metal silicate are reacted in an aqueous solution to produce a slurry of magnesium silicate, which may be a hydrated magnesium silicate, suspended in an aqueous solution. The slurry then is filtered, and the collected magnesium silicate is washed, dried, and classified for particle size. Examples of such synthetic magnesium silicates which may be employed are described in U.S. Pat. Nos. 4,681,768; 5,006,356; 5,597,600; 7,635,398; and 9,295,810.

In a non-limiting embodiment, the magnesium silicate is reacted with at least one reactive aminoalkylsilane, thereby providing an amino-functionalized magnesium silicate, wherein the amino-functionalized magnesium silicate is not in the form of a cationic species.

In a non-limiting embodiment, reactive aminoalkylsilanes which may be reacted with the at least one silica material, such as silica gel or magnesium silicate, include, but are not limited to, such as 3-aminopropyltriethoxysilane, 3-aminopropylmethyldiethoxysilane, 3-aminopropyldimethylethoxysilane, 3-aminopropyltrimethoxysilane, 3-aminopropylmethyldimethoxysilane, 3-aminopropyldimethylmethoxysilane, 3-aminopropyltrichlorosilane, 3-aminopropylmethyldichlorsilane, 3-aminopropyldimethylchloroxysilane, 4-aminobutyltriethoxysilane, 4-aminobutylmethyldiethoxysilane, 4-aminobutyldimethylethoxysilane, 4-aminobutyltrimethoxysilane, 4-aminobutylmethyldimethoxysilane, 4-aminobutyldimethylmethoxysilane, 4-aminobutyltrichlorosilane, 4-aminobutylmethyldichlorsilane, 4-aminobutyldimethylchloroxysilane, 3-(2-aminoethylamino)propyltriethoxysilane, 3-(2-aminoethylamino)propyltrimethoxysilane, 3-[2-(2-aminoethylamino)ethylamino]propyltriethoxysilane, 3-[2-(2-aminoethylamino)ethylamino]propyl-trimethoxysilane or other amino-terminated reactive silanes. Other reactive aminoalkylsilane linkers as are known in the art also may be used.

In a non-limiting embodiment, the at least one reactive aminoalkylsilane is selected from the group consisting of 3-aminopropyltriethoxysilane and 3-aminopropyltrimethoxysilane.

In another non-limiting embodiment, the at least one reactive aminoalkylsilane is selected from the group consisting of 3-(2-aminoethylamino)propyltriethoxysilane and 3-(2-aminoethylamino)propyltrimethoxysilane.

In yet another non-limiting embodiment, the at least one reactive aminoalkylsilane is selected from the group consisting of 3-[2-(2-aminoethylamino)ethylamino]propyltriethoxysilane and 3-[2-(2-aminoethylamino)ethylamino]propyltrimethoxysilane.

In a non-limiting embodiment, the at least one amino-functionalized adsorbent has an amino content of at least 0.001 millimoles per gram.

In another non-limiting embodiment, the at least one amino-functionalized silica adsorbent material has an amino content of from about 0.01 millimoles per gram to about 4.0 millimoles per gram.

In a non-limiting embodiment, the at least one amino-functionalized silica adsorbent material has a pH in a 5% slurry of from about 8.0 to about 11.5. In another non-limiting embodiment, the at least one amino-functionalized silica adsorbent material has a pH in a 5% slurry of from about 9.0 to about 10.0.

### BRIEF DESCRIPTION OF THE DRAWINGS

The invention now will be described with respect to the drawings, wherein:

FIG. 1 is a graph showing the amounts of residual free fatty acids after treating used cooking oil containing 1.0 wt. % free fatty acids with two commercially available aminopropyl-functionalized silica gels, and are compared to an unmodified silica gel;

FIG. 2 is a graph showing the amounts of residual free fatty acids after treatment of an oil containing 1.0 wt. % free fatty acids with the aminopropyl-functionalized silica gels of Examples 3 through 5, as compared to an unmodified silica gel;

FIG. 3 is a graph showing a comparison of the amounts of residual free fatty acids after treatment of an oil containing 1.0 wt. % free fatty acids with the aminopropyl-functionalized silica gel of Example 5 with Commercial Product 1 (Comparative Example 1) and Commercial Product 2 (Comparative Example 2);

FIG. 4 is a graph showing the amounts of residual soap after treatment of an oil containing 1.0 wt. % free fatty acids with either the aminopropyl-functionalized silica gel of Example 5, Commercial Product 1, or Commercial Product 2;

FIG. 5 is a graph showing the amounts of residual free fatty acids after treatment of a used cooking oil containing 1.0 wt. % free fatty acids with either unmodified silica gel, or the 3-(ethylenediamino) propyl-functionalized silica gels of Examples 6 and 7;

FIG. 6 is a graph showing the amounts of residual free fatty acids after treatment of an oil containing 1.0 wt. % free fatty acids with the commercially obtained 3-(diethylenetriamino) propyl-functionalized silica gel of Example 8, as compared to an unmodified silica gel; and

FIG. 7 is a graph showing the amounts of residual free fatty acids after treatment of an oil containing 1.0 wt. % free fatty acids with samples of aminopropyl-functionalized magnesium silicate (Examples 9, 10, and 11), or an unmodified magnesium silicate.

### EXAMPLES

The invention now will be described with respect to the following examples. It is to be understood, however, that the scope of the present invention is not intended to be limited thereby.

Eleven different amino-functionalized silica adsorbents were tested for removal of free fatty acids from a preheated cooking oil using a front-loading method of oil treatment. The front-loading method of oil treatment used a Modified Gelman Filter apparatus that mimicked a restaurant three-vat fryer setup. 3.6 grams of adsorbent powder were used to treat preheated oil that was divided into three equal amounts (60 grams) followed by sequential filtrations with 5 minutes of oil circulation per filtration. This oil treatment was a 2 wt. % dosing of adsorbent based on the total weight (180 grams) of the oil that was treated. The oil collected at the end of each cycle was analyzed for residual free fatty acids and soap by standard titration methods.

The eleven amino-functionalized silica materials tested were as follows:

### Example 1

3 aminopropyl-functionalized silica gel having a particle size of 40 to 63 microns and an amine loading of about 1 mmol NH₂/g adsorbent, obtained from Sigma-Aldrich.

### Example 2

3 aminopropyl-functionalized silica gel having a particle size of 40 to 63 microns, and an amine loading of about 1.4 mmol NH₂/g adsorbent, obtained from ACROS Organics.

### Example 3

100 g of silica gel having a particle size of 40 to 63 microns, 20 g of water, and 200 g of ethanol were charged into a 1 liter reactor. The mixture was stirred and heated to 75° C. 31.3 g of 3-aminopropyltriethoxysilane were mixed with 63 g of ethanol, and added slowly to the mixture over 35 minutes. The mixing was continued for 3 hours at 75° C., and then the mixture was cooled to 40° C. The resulting suspension was vacuum filtered using a Buchner funnel over a Whatman #2 filter paper. The resulting wet cake was washed with 400 g of water, followed by 400 g of ethanol. The material then was placed in an oven and dried at 107° C. for 6 hours. Target amine loading was 1.4 mmol NH₂/g adsorbent.

### Example 4

An aminopropyl-functionalized silica gel was prepared in accordance with Example 3, except that 44.7 g of 3-aminopropyltriethoxysilane mixed with 90 g of ethanol were used. Target amine loading was 2.0 mmol NH₂/g adsorbent.

### Example 5

An aminopropyl-functionalized silica gel was prepared in accordance with Example 3 except that 62.6 g of 3-aminopropyltriethoxysilane mixed with 125.0 g of ethanol were used. Target amine loading was 2.8 mmol NH₂/g adsorbent.

### Example 6

3-(ethylenediamino) propyl-functionalized silica gel having an amine loading of 0.8 mmol NH₂/g adsorbent, obtained from ACROS Organics.

### Example 7

3-(ethylenediamino) propyl-functionalized silica gel having an amine loading of 1.4 mmol NH₂/g adsorbent, obtained from TCI America.

### Example 8

3-(diethylenetriamino) propyl-functionalized silica gel having an amine loading of 1.4 mmol NH₂/g adsorbent, obtained from Sigma Aldrich.

### Example 9

100 g of an amorphous hydrous precipitated synthetic magnesium silicate, treated to reduce the pH thereof to less than 9.0, and manufactured under the trade name Magnesol® XL by the Dallas Group of America, Inc., Whitehouse, N.J., and described in U.S. Pat. No. 5,006,356, 20 g of water, and 200 g of ethanol were charged into a 1 liter reactor. The mixture was stirred and heated to 75° C. 11.2 g of 3-aminopropyltriethoxysilane was mixed with 25 g of ethanol and added slowly to the mixture in the reactor over 35 minutes. Mixing was continued at 75° C. for 3 hours, and then the mixture was cooled to 40° C. The resulting suspension was vacuum filtered using a Buchner funnel over a Whatman #2 filter paper. The resulting wet cake was washed with 400 g of water, followed by 400 g of ethanol. The material then was placed in an oven and dried at 107° C. for 6 hours. Target amine loading was 0.5 mmol NH₂/g adsorbent.

### Example 10

An aminopropyl-functionalized magnesium silicate was prepared in accordance with Example 9 except that 33.5 g of 3-aminopropyltriethoxysilane mixed with 67 g of ethanol were used. Target amine loading was 1.5 mmol NH₂/g adsorbent.

### Example 11

An aminopropyl-functionalized magnesium silicate was prepared in accordance with Example 9 except that 67.0 g of 3-aminopropyltriethoxysilane mixed with 135 g of ethanol were used. Target amine loading was 3.0 mmol NH₂/g adsorbent.

### Comparative Example 1

Commercial Product 1, a blend of sodium silicate and silica gel.

### Comparative Example 2

Commercial Product 2, a blend of sodium silicate and silica gel.

### Results

The aminopropyl-functionalized silica gels were evaluated for free fatty acid removal by the front-loading oil treatment method. Restaurant-used frying oil was treated with the functionalized silica gel placed on filter media (Oberlin EVO 80) in the Modified Gelman Filter Apparatus. Three sequential filtrations using oil (60 g) preheated to 325° F. were performed on the material (3.6 g) and the oil was circulated for 5 minutes per filtration cycle. The oil collected at the end of each cycle was analyzed for residual free fatty acids and soap by standard titration methods.

FIG. 1 shows residual free fatty acids after treatment of used frying oil containing 1.0% free fatty acids with two commercially available aminopropyl-functionalized silica gel materials and are compared to unmodified silica gel having the same particle size. No residual soap was produced during this treatment. As shown in FIG. 1, the aminopropyl-functionalized silica gels of Examples 1 and 2 provided for improved removal of free fatty acids when compared to an unmodified silica gel.

The preparation of 3-aminopropyl functionalized silica gel materials were achieved by using slurry/suspension methods. Three AP-Silica gels materials were prepared, which targeted 1.4, 2.0, and 2.8 mmol/g of amine loading.

The aminopropyl-functionalized silica gels were evaluated for free fatty acid removal by the front-loading oil treatment method. Used restaurant frying oil having about 1.0% free fatty acids with no soap (0 ppm) was treated with amino-functionalized silica gel placed on filter media (Oberlin EVO 80) in the Modified Gelman Filter Apparatus. Three successive filtrations using oil (60 g) preheated to 325° F. were performed on the material (3.6 g) and the oil was circulated for 5 minutes per filtration cycle. The oil collected at the end of each cycle was analyzed for residual free fatty acids and soap by standard titration methods.

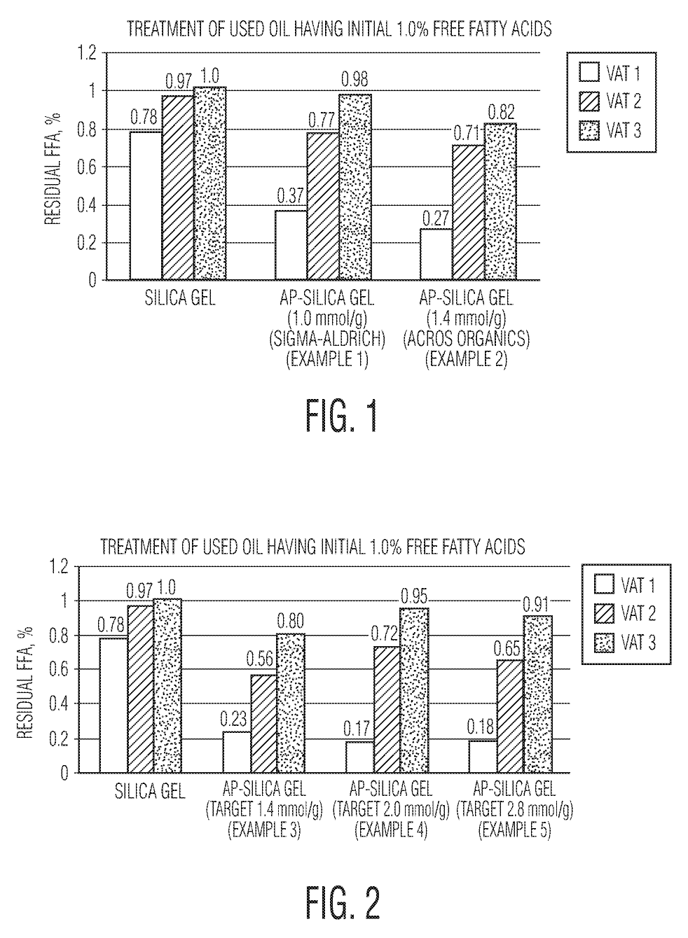

FIG. 2 shows residual free fatty acids after treatment of an oil containing 1.0% free fatty acids with the aminopropyl-functionalized silica gels of Examples 3 through 5. These silica gels were compared to unmodified silica gel. The aminopropyl-functionalized silica gels of Examples 3, 4, and 5 provided for improved removal of free fatty acids when compared to the unmodified silica gel.

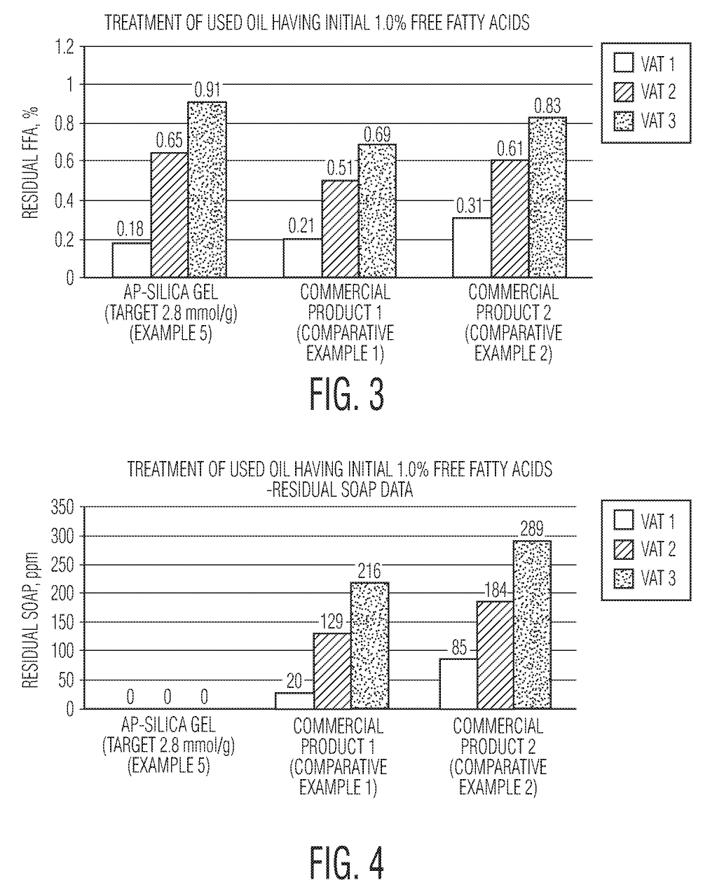

FIG. 3 shows a comparison of residual free fatty acids after treatment of an oil containing 1.0% free fatty acids with the aminopropyl-functionalized silica gel of Example 5 to Commercial Product 1 and Commercial Product 2.

Although Commercial Products 1 and 2 provided favorable results for free fatty acid removal compared to the aminopropyl-functionalized silica gel of Example 5, Commercial products 1 and 2 produced large amounts of soaps, due to the presence of sodium silicate, which are not removed by filtration as shown in FIG. 4.

FIG. 4 shows a comparison of residual soap after treatment of an oil containing 1.0% free fatty acids with the aminopropyl-functionalized silica gel of Example 5 to Commercial Product 1 and Commercial Product 2. The aminopropyl-functionalized silica gel of Example 5 did not produce any soap (The materials contain no alkali or alkaline materials.), whereas Commercial Product 1 and Commercial Product 2 produced significant amounts of soap. Residual soaps at high levels (above 200 ppm) can create excess foaming in frying oils and fats, which can be problematic when deep frying food and in addition residual soaps in frying oil catalyze degradation of oil during frying.

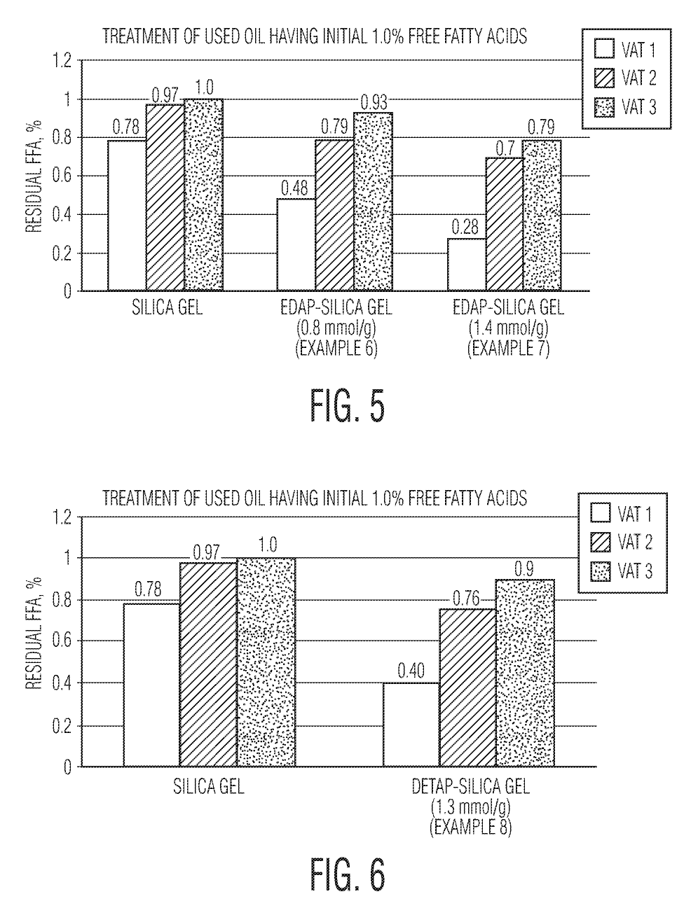

FIG. 5 shows a comparison of residual free fatty acids after treatment of used restaurant oil having 1.0% free fatty acids with the 3-(ethylenediamino) propyl-functionalized silica gels of Examples 6 and 7 to unmodified silica gel. No residual soap was detected. The amino-functionalized silica gels of Examples 6 and 7 provided for improved removal of free fatty acids compared to unmodified silica gel.

FIG. 6 shows a comparison of residual free fatty acids after treatment of an oil containing 1.0% free fatty acids treated with the 3-(diethylenetriamino) propyl-functionalized silica gel of Example 8 to unmodified silica gel. Improved removal of free fatty acids was provided by the amino-functionalized silica gel of Example 8, compared to the unmodified silica gel.

The functionalization of synthetic magnesium silicate (Magnesol® XL, The Dallas Group of America, Inc., Whitehouse, N.J.) with 3-aminopropyltriethoxysilane was performed by a slurry/suspension method in water and ethanol as hereinabove described, in order to prepare magnesium silicates with amine loadings of 0.5 mmol/g (Example 9), 1.5 mmol/g (Example 10), and 3.0 mmol/g (Example 11).

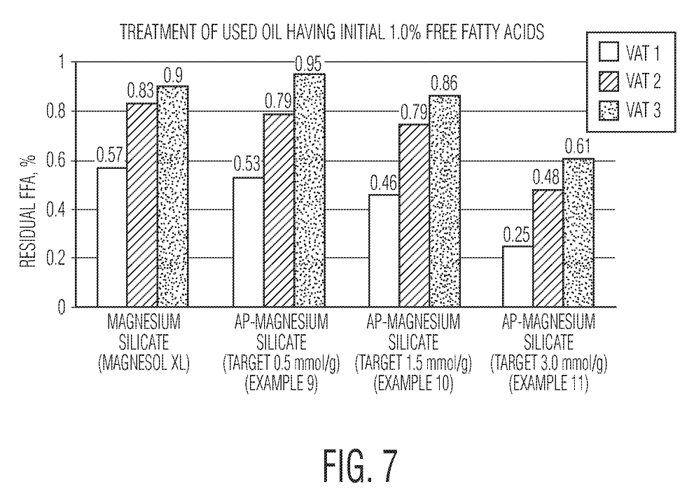

FIG. 7 shows residual free fatty acids after treatment of a frying oil containing 1.0% free fatty acids with the amino-functionalized synthetic magnesium silicates of Examples 9, 10, and 11, as compared to unmodified synthetic magnesium silicate (Magnesol® XL). In general, the amino-functionalized magnesium silicates provided for improved removal of free fatty acids compared to the unmodified magnesium silicate.

Table 1 shows nitrogen content from elemental analysis, calculated amine loading, and pH of prepared aminopropyl-functionalized silica gels and magnesium silicates and are compared to unmodified raw materials.

TABLE 1

| | | Amine | |
|---|---|---|---|
| | | Loading | |
| | | Based on | |
| | Elemental | Elemental | |
| | Analysis, % | Analysis, | |
| | Nitrogen | mmol/g | pH |
| Silica Gel | 0 | 0 | 6.2 |
| AP-Silica Gel (Target 1.4 mmol/g), | 1.70 | 1.33 | 9.1 |
| Example 3 | | | |
| AP-Silica Gel (Target 2.0 mmol/g), | 2.25 | 1.82 | 9.6 |
| Example 4 | | | |
| AP-Silica Gel (Target 2.8 mmol/g), | 2.67 | 2.23 | 10.0 |
| Example 5 | | | |
| Magnesium Silicate (Magnesol XL) | 0 | 0 | 9.0 |
| AP-Magnesium Silicate (Target 0.5 | 0.74 | 0.54 | 10.0 |
| mmol/g), Example 9 | | | |
| AP-Magnesium Silicate (Target 1.5 | 2.04 | 1.63 | 11.1 |
| mmol/g), Example 10 | | | |
| AP-Magnesium Silicate (Target 3.0 | 2.33 | 2.05 | 10.6 |
| mmol/g), Example 11 | | | |

Table 2 shows BET surface area and total pore volume data of prepared aminopropyl-functionalized silica gels and magnesium silicates and are compared to unmodified raw materials.

TABLE 2

| | BET | |
|---|---|---|
| | Surface Area, | Total Pore |
| | m²/g | Volume, cc/g |
| Silica Gel | 536 | 0.768 |
| AP-Silica Gel (Target 1.4 mmol/g), | 355 | 0.544 |
| Example 3 | | |
| AP-Silica Gel (Target 2.0 mmol/g), | 353 | 0.483 |
| Example 4 | | |
| AP-Silica Gel (Target 2.8 mmol/g), | 339 | 0.440 |
| Example 5 | | |
| Magnesium Silicate (Magnesol XL) | 566 | 0.680 |
| AP-Magnesium Silicate (Target 0.5 | 565 | 0.677 |
| mmol/g), Example 9 | | |
| AP-Magnesium Silicate (Target 1.5 | 397 | 0.575 |
| mmol/g), Example 10 | | |
| AP-Magnesium Silicate (Target 3.0 | 154 | 0.340 |
| mmol/g), Example 11 | | |

The disclosures of all patents and publications, including published patent applications, are hereby incorporated by reference to the same extent as if each patent and publication were incorporated individually by reference.

It is to be understood, however, that the scope of the present invention is not to be limited by the specific embodiments described above. The invention may be practiced other than as particularly described and still be within the scope of the accompanying claims.

What is claimed is:

1. A method of purifying cooking oil or fat, comprising:
contacting said cooking oil or said fat with at least one amino-functionalized silica adsorbent material, wherein said at least one amino-functionalized silica adsorbent material is not in the form of a cationic species, wherein said cooking oil or said fat is contacted with said amino-functionalized silica adsorbent material in an amount effective to purify said cooking oil or said fat.

2. The method of claim 1 wherein said at least one amino-functionalized silica adsorbent material is produced by reacting at least one silica material with at least one reactive aminoalkylsilane.

3. The method of claim 2 wherein said at least one silica material is selected from the group consisting of silica gel, magnesium silicate, calcium silicate, sodium silicate, aluminum silicate, sodium aluminum silicate, and combinations thereof.

4. The method of claim 3 wherein said at least one silica material is magnesium silicate.

5. The method of claim 2 wherein said at least one reactive aminoalkylsilane is selected from the group consisting of 3-aminopropyltriethoxysilane, 3-aminopropylmethyldiethoxysilane, 3-aminopropyldimethylethoxysilane, 3-aminopropyltrimethoxysilane, 3-aminopropylmethyldimethoxysilane, 3-aminopropyldimethylmethoxysilane, 3-aminopropyltrichlorosilane, 3-aminopropylmethyldichlorsilane, 3-aminopropyldimethylchloroxysilane, 4-aminobutyltriethoxysilane, 4-aminobutylmethyldiethoxysilane, 4-aminobutyldimethylethoxysilane, 4-aminobutyltrimethoxysilane, 4-aminobutylmethyldimethoxysilane, 4-aminobutyldimethylmethoxysilane, 4-aminobutyltrichlorosilane, 4-aminobutylmethyldichlorsilane, 4-aminobutyldimethylchloroxysilane, 3-(2-aminoethylamino)propyltriethoxysilane, 3-(2-aminoethylamino)propyltrimethoxysilane, 3-[2-(2-aminoethylamino)ethylamino]propyltriethoxysilane, and 3-[2-(2-aminoethylamino)ethylamino]propyl-trimethoxysilane.

6. The method of claim 5 wherein said at least one reactive aminoalkylsilane is selected from the group consisting of 3-aminopropyltriethoxysilane and 3-aminopropyltrimethoxysilane.

7. The method of claim 5 wherein said at least one reactive aminoalkylsilane is selected from the group consisting of 3-(2-aminoethylamino)propyltriethoxysilane and 3-(2-aminoethylamino)propyltrimethoxysilane.

8. The method of claim 5 wherein said at least one reactive aminoalkylsilane is selected from the group consisting of 3-[2-(2-aminoethylamino)ethylamino]propyltriethoxysilane and 3-[2-(2-aminoethylamino)ethylamino]propyl-trimethoxysilane.

9. The method of claim 3 wherein said at least one silica material is silica gel.

10. The method of claim 1 wherein said at least one amino-functionalized silica adsorbent material has an amino content of at least 0.001 millimoles per gram.

11. The method of claim 10 wherein said at least one amino-functionalized silica adsorbent material has an amino content of from about 0.01 millimoles per gram to about 4.0 millimoles per gram.

12. The method of claim 1 wherein said at least one amino-functionalized silica adsorbent material has a pH in a 5% slurry of from about 8.0 to about 11.5.

13. The method of claim 12 wherein said at least one amino-functionalized silica adsorbent material has a pH in a 5% slurry of from about 9.0 to about 10.0.
